(19) United States
(12) Patent Application Publication
(10) Pub. No.: US 2005/0265777 A1
(43) Pub. Date: Dec. 1, 2005

(54) Modular assembly having tubular components

(76) Inventor: Wen-Pin Lin, Taichung City (TW)

Correspondence Address: FROMMER LAWRENCE & HAUG, 745 FIFTH AVENUE- 10TH FL., NEW YORK, NY, 10151, US

(21) Appl. No.: 10/857,699

(22) Filed: May 28, 2004

(51) Int. Cl. F16B 1/00

(52) U.S. Cl. 403/169

(57) ABSTRACT

A modular assembly includes a plate component attached to a tubular component having opposed first and second holes by means of a coupling tube, a clamp plate, and first and second screws. The coupling tube is inserted into the tubular component, and has first and second open ends extending respectively through the first and second holes, a clamping flange, and an internal screw thread. The clamp plate is disposed over the tubular component, and has a slot and two clamp end portions cooperating with the clamping flange to clamp the tubular component therebetween. The plate component abuts against the clamp plate, and is formed with a through hole. The first screw engages the internal screw thread through the first open end. The second screw engages the internal screw thread by passing through the through hole in the plate component, the slot, and the second open end.

### BACKGROUND OF THE INVENTION

1. Field of the Invention

The invention relates to a modular assembly, more particularly to a modular assembly having tubular components and plate components.

2. Description of the Related Art

Tubular parts and plate parts used in assembling a toy are generally interconnected by using screws and nuts. Although the assembly is simple, there is no positioning structure between the tubular parts and the to-be-attached component part so that connection between the two is not stable.

### SUMMARY OF THE INVENTION

Therefore, the object of the present invention is to provide a modular assembly having tubular components that are firmly and stably attachable to plate components.

According to one aspect of this invention, a modular assembly comprises a tubular component, a coupling tube, a clamp plate, a plate component, and first and second screws. The tubular component has an axially extending hole, a peripheral wall surrounding the hole, and a pair of diametrically opposed first and second holes formed in the peripheral wall and in spatial communication with the hole. The coupling tube is inserted into the tubular component, and includes a tube wall having first and second open ends extending respectively through the first and second holes, a clamping flange projecting outwardly from the first open end to abut against an outer surface of the peripheral wall, and an internal screw thread formed in the tube wall and extending from the first open end to the second open end. The clamp plate is disposed over the peripheral wall, and has a slot formed therein in alignment with the second open end, and two clamp end portions formed on two opposite sides of the slot to abut against the outer surface of the peripheral wall. The plate component abuts against the clamp plate, and is formed with a through hole. Each of the first and second screws has a head portion and a threaded shank portion extended from the head portion. The shank portion of the first screw extends into the first open end, and engages the internal screw thread. The shank portion of the second screw passes through the through hole in the plate component and the slot, and extends into the second open end to engage the internal screw thread. The clamping flange and the clamp end portions cooperate to clamp the tubular component therebetween when the first and second screws are tightened.

According to another aspect of this invention, a modular assembly comprises a support frame, a sloping trough, a coupling tube, a clamp plate, and first and second screws. The support frame is composed of a plurality of tubular components, and has an upper part and a lower part. Each of the tubular components has an axially extending hole, a peripheral wall surrounding the hole, and a pair of diametrically opposed first and second holes formed in the peripheral wall and in spatial communication with the hole. The sloping trough is supported by the frame, extends downwardly from the upper part to the lower part, and has a plate component formed with a through hole. The coupling tube is inserted into one of the tubular components, and includes a tube wall having first and second open ends extending respectively through the first and second holes, a clamping flange projecting outwardly from the first open end to abut against an outer surface of the peripheral wall, and an internal screw thread formed in the tube wall and extending from the first open end to the second open end. The clamp plate is disposed over the peripheral wall, and has a slot formed therein in alignment with the second open end, and two clamp end portions formed on two opposite sides of the slot to abut against the outer surface of the peripheral wall. The plate component abuts against the clamp plate. Each of the first and second screws has a head portion and a threaded shank portion extended from the head portion. The shank portion of the first screw extends into the first open end, and engages the internal screw thread. The shank portion of the second screw passes through the through hole in the plate component and the slot, and extends into the second open end to engage the internal screw thread. The clamping flange and the clamp end portions cooperate to clamp said one of the tubular components therebetween when the first and second screws are tightened.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of the preferred embodiment of a modular assembly according to the present invention;

FIG. 2 is a fragmentary exploded perspective view, illustrating a tubular component, a coupling tube, a clamp plate, and first and second screws of the preferred embodiment;

FIG. 3 is a fragmentary perspective view, illustrating the tubular component with two pairs of diametrically opposed first and second holes; and

FIG. 4 is a fragmentary sectional view of the preferred embodiment in an assembled state.

### DETAILED DESCRIPTION OF THE PREFERRED EMBODIMENT

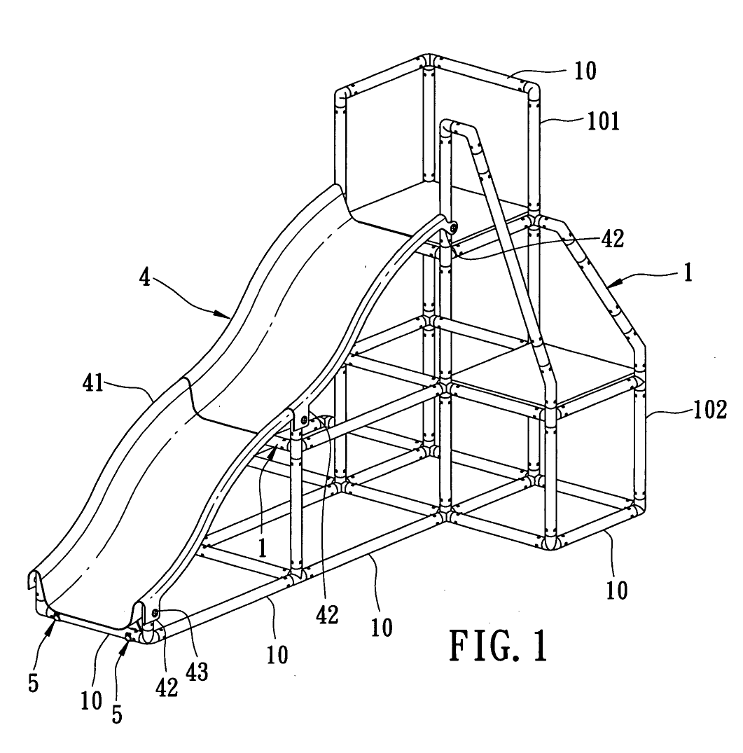

Referring to FIGS. 1 to 4, a modular assembly according to the present invention is shown to be embodied in a slide that comprises a support frame 1, and a sloping trough 4 supported by the support frame 1 and extending downwardly from an upper part 101 to a lower part 102 of the support frame 1. The support frame 1 is composed of a plurality of tubular components 10. The sloping trough 4 has a plurality of plate components 42. According to the present invention, the plate components 42 are attached to the tubular components 10 of the support frame 1 by means of a coupling tube 2, a clamp plate 3, and first and second screws 5, 5′.

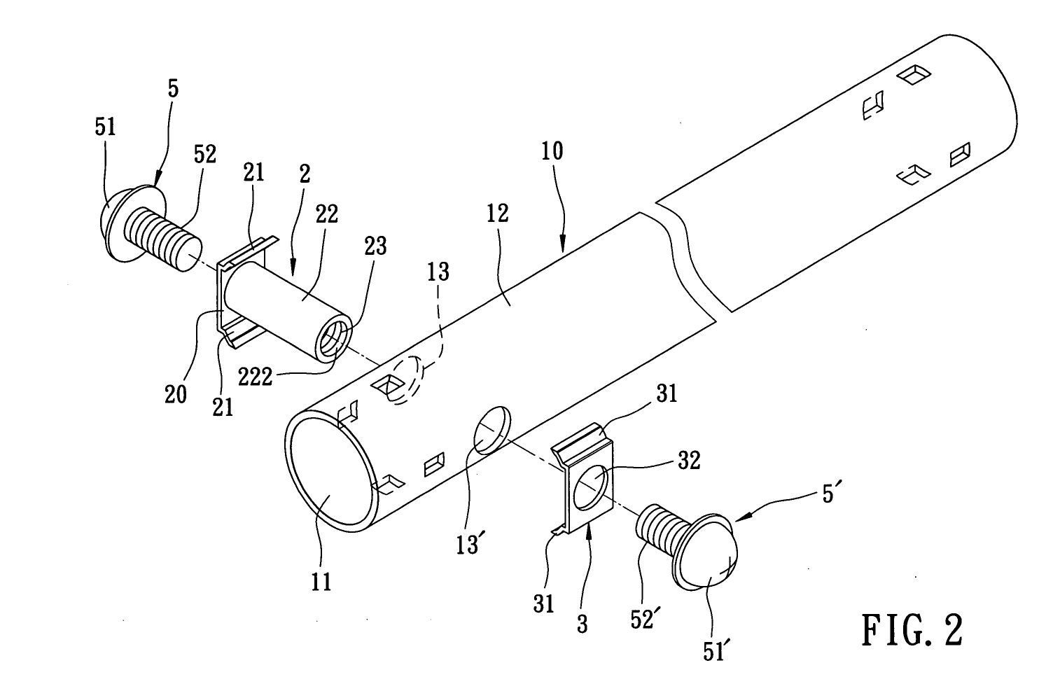

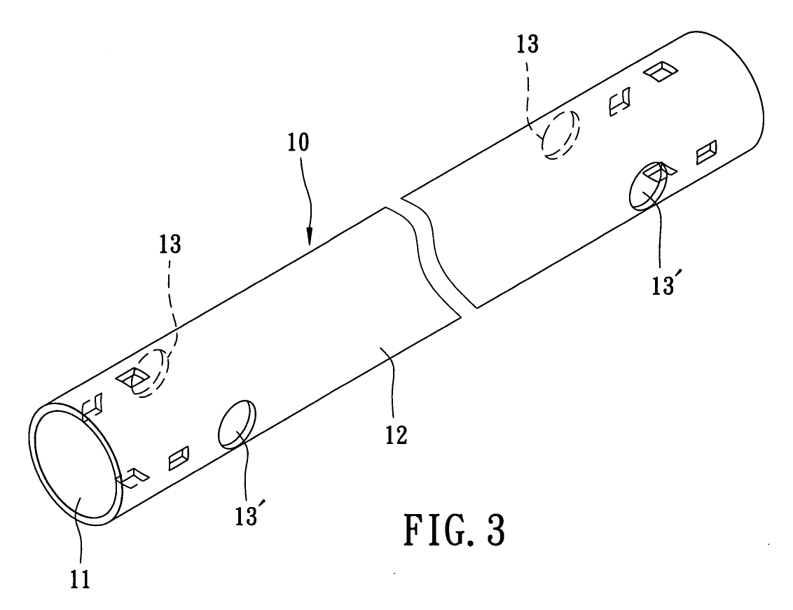

Each of the tubular components 10 is made of aplastic material, and has a circular cross section. The plastic material is preferably an acrylonitrile butadiene styrene (ABS) polymer. Each tubular component 10 has an axially extending hole 11, a peripheral wall 12 surrounding the hole 11, and a pair of diametrically opposed first and second holes 13, 13′ formed in the peripheral wall 12 and in spatial communication with the hole 11. In this embodiment, each of the tubular components 10 can be formed with one pair of diametrically opposed first and second holes 13, 13′ (see FIG. 2) or two pairs of diametrically opposed first and second holes 13, 13′ (see FIG. 3) depending on the assembly requirement.

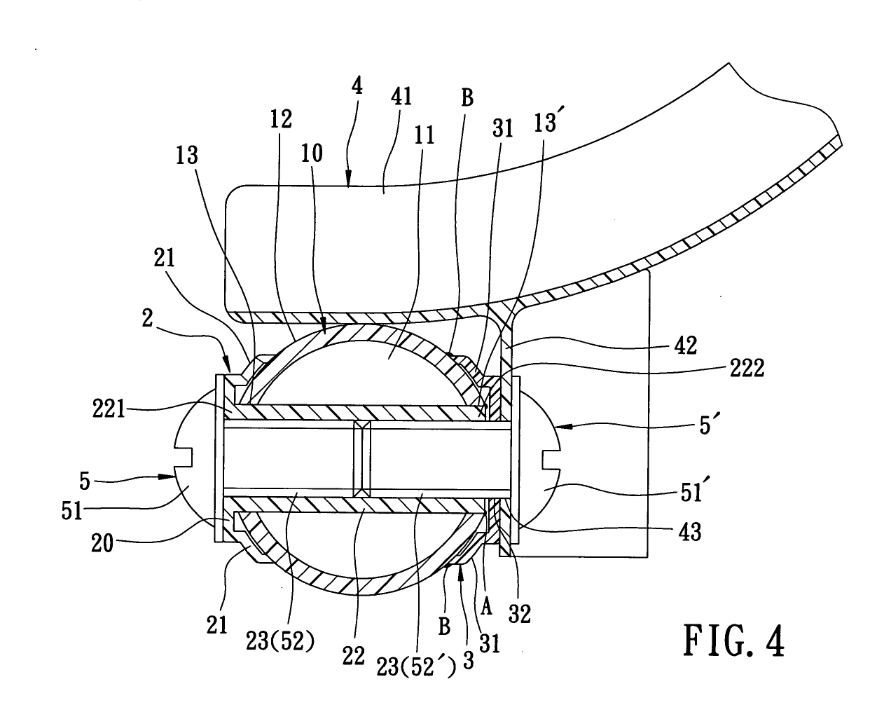

The coupling tube 2 is made of a plastic material, such as an acrylonitrile butadiene styrene (ABS) polymer. The coupling tube 2 includes a tube wall 22, a clamping flange 20, and an internal screw thread 23. The tube wall 22 has a first open end 221 (see FIG. 4) and a second open end 222 opposite to the first open end 221. The clamping flange 20 projects outwardly from the first open end 221 so as to abut against an outer surface of the peripheral wall 12 of the corresponding tubular component 10. The clamping flange 20 has two abutment portions 21 which are curved to conform to the outer surface of the peripheral wall 12. The internal screw thread 23 is formed in the tube wall 22, and extends from the first open end 221 to the second open end 222. During assembly, the tube wall 22 is inserted into the corresponding tubular component 10 with the first and second open ends 221, 222 extending respectively through the first and second holes 13, 13′, after which the second open end 222 of the tube wall 22 is fixed to the peripheral wall 12 of the corresponding tubular component 10 by high frequency sealing. The sealed part is represented by (A) in FIG. 4.

Each of the clamp plates 3 is made of a plastic material, and has a slot 32 formed therein, and two curved clamp end portions 31 formed on two opposite sides of the slot 32 so as to abut against the outer surface of the peripheral wall 12 of the corresponding tubular component 10. The plastic material is preferably an acrylonitrile butadiene styrene (ABS) polymer. The clamp end portions 31 are curved to conform to the outer surface of the peripheral wall 12 of the corresponding tubular component 10. During assembly, the slot 32 is aligned with the second open end 222 of the corresponding coupling tube 2, after which the clamp end portions 31 are fixed to the outer surface of the peripheral wall 12 of the corresponding tubular component 10 by high frequency sealing. The sealed part is represented by (B) in FIG. 4.

The sloping trough 4 has a certain degree of curvature, and is made of a plastic material, such as an acrylonitrile butadiene styrene (ABS) polymer. As shown in FIG. 4, the plate component 42 extends downwardly from a main body 41 of the sloping trough 4, and is formed with a through hole 43 that is aligned with the slot 32 in the clamp plate 3 and the second open end 222 of the coupling tube 2.

Each of the first and second screws 5, 5′ is made of a plastic material, and has a large head portion 51, 51′, and a threaded shank portion 52, 52′ extended from the head portion 51, 51′. The plastic material is preferably an acrylonitrile butadiene styrene (ABS) polymer. During assembly, the shank portion 52 of the first screw 5 extends into the first open end 221, and engages the internal screw thread 23 in the tube wall 22 of the coupling tube 2. The shank portion 52′ of the second screw 5′ passes through the through hole 43 in the plate component 42 and the slot 32 in the clamp plate 3, and extends into the second open end 222 so as to engage the internal screw thread 23 in the tube wall 22 of the coupling tube 2.

Since the abutment portions 21 of the coupling tube 2 and the clamp end portions 31 of the clamp plate 3 are curved so as to conform to the outer surface of the peripheral wall 12 of the tubular component 10, the coupling tube 2 and the clamp plate 3 can be attached fixedly to the peripheral wall 12 of the tubular component 10. Furthermore, the abutment portions 21 and the clamp end portions 31 cooperate to clamp the tubular component 10 therebetween when the first and second screws 5, 5′ are tightened.

Through cooperation of the coupling tube 2 and the clamp plate 3 with the first and second screws 5, 5′, the plate components 42 of the sloping trough 4 are connected stably to the pre-assembled support frame 1 which is composed of the tubular components 10. Hence, the modular assembly of the present invention is not only stable when connected, but is safe to use as well.

Moreover, although the coupling tube 2 and the clamp plate 3 can be positioned stably on the corresponding tubular component 10 simply by use of the first and second screws 5, 5′ as described above, the abutment portions 21 and the clamp end portions 31 can be fixed to the corresponding tubular component 10 by high frequency sealing during manufacture and prior to assembling of the sloping trough 4 to the support frame 1. This is made possible by the fact that the tubular components 10, the coupling tube 2, and the clamp plate 3 are made of acrylonitrile butadiene styrene (ABS) polymer in the preferred embodiment. Therefore, the strength and durability of the whole system are enhanced, and the number of steps required for assembly is reduced. Thus, the remaining step for connecting the sloping trough 4 to the tubular components 10 would be to thread and tighten the first and second screws 5, 5′.

To disassemble the modular assembly of the present invention, only a small coin (not shown) is needed to rotate and loosen the first and second screws 5, 5′. Therefore, assembling and disassembling of the modular assembly of the present invention are simple and easy.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A modular assembly comprising:
a tubular component having an axially extending hole, a peripheral wall surrounding said hole, and a pair of diametrically opposed first and second holes formed in said peripheral wall and in spatial communication with said hole;
a coupling tube inserted into said tubular component, and including a tube wall having first and second open ends extending respectively through said first and second holes, a clamping flange projecting outwardly from said first open end to abut against an outer surface of said peripheral wall, and an internal screw thread formed in said tube wall and extending from said first open end to said second open end;
a clamp plate disposed over said peripheral wall and having a slot formed therein in alignment with said second open end, and two clamp end portions formed on two opposite sides of said slot to abut against said outer surface of said peripheral wall;
a plate component abutting against said clamp plate and formed with a through hole; and
first and second screws, each of which has a head portion and a threaded shank portion extended from said head portion, said shank portion of said first screw extending into said first open end and engaging said internal screw thread, said shank portion of said second screw passing through said through hole in said plate component and said slot and extending into said second open end to engage said internal screw thread;
wherein said clamping flange and said clamp end portions cooperate to clamp said tubular component therebetween when said first and second screws are tightened.

2. The modular assembly as claimed in claim 1, wherein said tubular component, said coupling tube, and said clamp plate are made of a plastic material, and said clamp end portions are fixed to said tubular component by high frequency sealing.

3. The modular assembly as claimed in claim 2, wherein said plastic material is an acrylonitrile butadiene styrene (ABS) polymer.

4. The modular assembly as claimed in claim 1, wherein said tubular component has a circular cross section, and said clamping flange and said clamp end portions are curved to conform to an outer surface of said peripheral wall of said tubular component.

5. A modular assembly comprising:
a support frame composed of a plurality of tubular components, and having an upper part and a lower part, each of said tubular components having an axially extending hole, a peripheral wall surrounding said hole, and a pair of diametrically opposed first and second holes formed in said peripheral wall and in spatial communication with said hole;
a sloping trough supported by said support frame and extending downwardly from said upper part to said lower part, said sloping trough having a plate component formed with a through hole;
a coupling tube inserted into one of said tubular components, and including a tube wall having first and second open ends extending respectively through said first and second holes, a clamping flange projecting outwardly from said first open end to abut against an outer surface of said peripheral wall, and an internal screw thread formed in said tube wall and extending from said first open end to said second open end;
a clamp plate disposed over said peripheral wall and having a slot formed therein in alignment with said second open end, and two clamp end portions formed on two opposite sides of said slot to abut against said outer surface of said peripheral wall, said plate component abutting against said clamp plate; and
first and second screws, each of which has a head portion and a threaded shank portion extended from said head portion, said shank portion of said first screw extending into said first open end and engaging said internal screw thread, said shank portion of said second screw passing through said through hole in said plate component and said slot and extending into said second open end to engage said internal screw thread;
wherein said clamping flange and said clamp end portions cooperate to clamp said one of said tubular components therebetween when said first and second screws are tightened.

6. The modular assembly as claimed in claim 5, wherein each of said tubular components, said coupling tube, and said clamp plate are made of a plastic material, and said clamp end portions are fixed to said one of said tubular components by high frequency sealing.

7. The modular assembly as claimed in claim 6, wherein said plastic material is an acrylonitrile butadiene styrene (ABS) polymer.

8. The modular assembly as claimed in claim 5, wherein each of said tubular components has a circular cross section, and said clamping flange and said clamp end portions are curved to conform to an outer surface of said peripheral wall of said tubular component.
